(19) United States
(12) Patent Application Publication
(10) Pub. No.: US 2016/0274904 A1
(43) Pub. Date: Sep. 22, 2016

(54) SYSTEM AND METHOD FOR GAMIFICATION OF COMMUNITY SOFTWARE DEVELOPMENT

(71) Applicant: OPEN SOURCE STORAGE LLC, Campbell, CA (US)

(72) Inventors: Eren L. Niazi, San Jose, CA (US); Marc Rotzow, San Jose, CA (US)

(21) Appl. No.: 15/073,028

(22) Filed: Mar. 17, 2016

Related U.S. Application Data
(60) Provisional application No. 62/134,705, filed on Mar. 18, 2015.

(51) Int. Cl. G06F 9/44; G06F 3/0481

(52) U.S. Cl. CPC G06F 8/70; G06F 3/04817

(57) ABSTRACT

Embodiments of the inventive concept provide a system and method for gamifying community driven open source software development projects, thereby spurring innovation and quality open source and freely available products. Embodiments of the inventive concept not only incentivizes the most desired tasks, such as coding, but also the less desirable actions like code review, documentation, quality assurance, testing, security analysis, and the like. In this manner, all steps along the software development path can be incentivized. Even scheduling and meeting deadlines for enhancements, bug fixes, and security auditing can benefit from an award system. Embodiments include a development gamification system including a user interface logic section to provide a development gamification interface to incentivize a community of users to develop open source software projects.

### RELATED APPLICATION DATA

This application claims the benefit of copending, commonly-owned U.S. provisional patent application Ser. No. 62/134,705, filed Mar. 18, 2015, which is hereby incorporated by reference.

### TECHNICAL FIELD

This application pertains to communication gamification for incentivization, and more particularly, to a system and method for gamificiation of community software development.

### BACKGROUND

Community-driven open source software has become a staple in the technology industry for businesses of all sizes as well as the home. There are millions of coding projects in the process of being created, modified, and enhanced. A community-driven, open source software project is defined as a software project whose source code is freely available to view, and is created by programmers who have come together for the purpose of creating software for the software project. The programmers form a community specifically for developing the software for the software project. This does not mean that anyone may contribute. Rather, open source software projects may still remain a tightly controlled project, such as the Linux® kernel. Linus Torvalds, the creator of Linux®, is the controller of the project and determines what is allowed in the kernel. In some cases, the controller may delegate to a chosen person to control certain parts to determine who may contribute. It is a tightly maintained community built around open source principles. Community-driven open source software is not anarchic, but rather meritocratic. A project and its maintainers are dedicated to the idea of building software, and will accept contributions from those who have demonstrated an ability to contribute positively to the project.

From the commonly-used Firefox® web browser, to the prevalent Linux® kernel, many people participate in the process of creating these open source projects. Some are successful and some are not. There are a variety of factors that contribute to the success or failure of an open source project. These factors include motivation, usefulness, and popularity.

Motivation can be monetary, as the business model for some companies is centered around support and licensing, such as like RedHat® or Mozilla®. Some companies, like Google®, help sponsor open source projects and also allow their employees paid time to work on side projects. With the advent of crowd-fundings sites, such as Kickstarter®, one can fund a project through private donation from a supportive community. But not all projects are motivated by monetary gains. Many programmers are motivated by a desire to create or to assist with a project that they believe in and are passionate about.

Usefulness is a measure of how useful a program is. An open source project like VideoLAN® community media player or “VLC,” has a very small group of maintainers, and the software tool is free. VLC offers the ability to view a large variety of video formats that would otherwise require downloading individual players. Large projects like the Apache® Webserver run the majority of the world's active web sites. It is a necessary part of most corporations' infrastructures. Apache® has a large number of modules that can extend its functionality. A similar project like Nginx® is a lighter-weight web server that can also act as a load balancer and a reverse proxy, like Squid proxy. These are all highly useful projects that have tremendous community support.

But for open source in general, one issue with acceptance has been concern about a project going unmaintained. Since many of the bigger projects have foundations behind them and the financial donations to support them, there is little chance that they will go unmaintained. Some have traction and strong financial backing. But not all open source projects are as fortunate. Another concern with open source software is documentation; often documentation receives little attention or is outdated. This may also be true of commercial software, but it is especially true in open source software.

Accordingly, a need remains for improved systems and methods for incentivization and gamificiation of community software development. Embodiments of the inventive concept address these and other limitations in the prior art.

### BRIEF DESCRIPTION OF THE DRAWINGS

FIG. 1 illustrates a block diagram of an example development gamification system in accordance with various embodiments of the present inventive concept.

FIG. 2 illustrates a block diagram of an example development gamification interface on a display device of the system of FIG. 1 including a project layout section in accordance with various embodiments of the present inventive concept.

FIG. 3 illustrates a block diagram of an example development gamification interface on a display device of the system of FIG. 1 including a user page layout section in accordance with various embodiments of the present inventive concept.

FIG. 4 is a flow diagram illustrating a technique for constructing and gamifying an open source project in accordance with various embodiments of the present inventive concept.

FIG. 5 illustrates a block diagram of an example development gamification interface on a display device of the system of FIG. 1 including an incentive layout section in accordance with various embodiments of the present inventive concept.

FIG. 6 illustrates a block diagram of an example development gamification interface on a display device of the system of FIG. 1 including a project management section in accordance with various embodiments of the present inventive concept.

The foregoing and other features of the inventive concept will become more readily apparent from the following detailed description, which proceeds with reference to the accompanying drawings.

### DETAILED DESCRIPTION OF THE EMBODIMENTS

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first interface could be termed a second interface, and, similarly, a second interface could be termed a interface, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

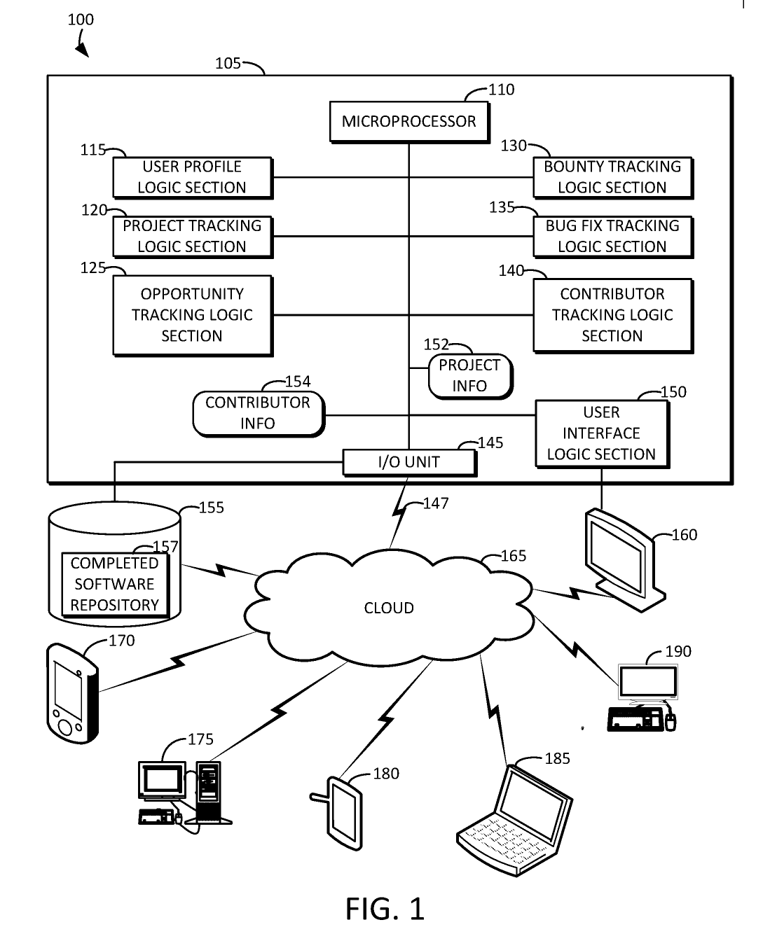

FIG. 1 illustrates a block diagram of an example development gamification system 100 in accordance with various embodiments of the present inventive concept. The development gamification system 100 can include a development gamification computer server 105. It will be understood that while a single specialized development gamification computer server 105 is shown, one or more specialized computer servers, one or more specialized virtual machines, one or more local computers, or one or more remote computers, or the like, can be used without departing from the inventive concepts disclosed herein.

The development gamification computer server 105 can be communicatively coupled to the cloud 165 via a network connection 147. The development gamification computer server 105 can be communicatively coupled, either directly or via the cloud 165, to a storage device 155, which can include a completed software repository 157, as further described below. The development gamification computer server 105 can be communicatively coupled, either directly or via the cloud 165, to a display device 160. The display device 160 is representative of any suitable display device, including touch-screen or non-touch-screen display devices, which can be used by a user to interface with the development gamification computer server 105 via a user interface logic section 150.

A variety of user devices can be used to interface with the development gamification computer server 105 via the user interface logic section 150. For example, a smart phone 170, a personal computer 175, a tablet computer 180, a laptop computer 185, a terminal 190, the display 160, or the like, can be used by the users to interface with the development gamification computer server 105 via the user interface logic section 150. The user interface logic section 150 of the development gamification computer server 105 can cause a user interface to be displayed on one or more of the user devices (e.g., 160, 170, 175, 180, 185, 190, or the like). In some embodiments, the user interface logic section 150 of the development gamification computer server 105 can cause the user interface to be displayed via a web browser and/or an application installed on the various user devices. In some embodiments, a client-side program can interface with the interface logic section 150 of the development gamification computer server 105, and cause the user interface to be displayed on the display of the user devices.

The development gamification computer server 105 can include a microprocessor 110, which can process information and logic for the development gamification computer server 105. The development gamification computer server 105 can include various logic section such as a user profile logic section 115, a project tracking logic section 120, an opportunity tracking logic section 125, a bounty tracking logic section 130, a bug fix tracking logic section 135, and a contributor tracking logic section 140, all of which are described in further detail below. The development gamification computer server 105 can also include an input/output unit 145, which can provide the physical network connection to the cloud 165, and which can transmit and receive information communicated with the user devices (e.g., 160, 170, 175, 180, 185, 190, or the like). The microprocessor 110 can process information or logic received from each of the logic sections of the development gamification computer server 105.

The development gamification computer server 105 can further include contributor information 154 about one or more contributors, and project information 152 about one or more open source software development projects. More specifically, a project can refer to a software application developed using the development gamification computer server 105, a module for such application, and/or a module for a different application. But a project is not merely source code. A project involves a deliberate effort, with adequate documentation, and good support to the end-users, all of which can be gamifyed using the various embodiments of the inventive concept disclosed herein. The development gamification computer server 105 need not merely incentivize code development, but can also incentivize multiple aspects of the project including the typically less-exciting aspects such as code documentation and support, thereby encouraging the completion of all aspects of the project.

The contributors are users of the development gamification computer server 105. For example, a contributor can be at least one of (a) a programmer who writes and submits code to a project, (b) a code-reviewer who reviews the code contributions of the programmers, (c) a quality assurance (QA) agent who tests the software and reports issues, bug, improvement suggestions, security suggestions, or clarifications, (d) a documentor who assists in the support of the software by documenting the code or answering questions of end-users of the software, or (e) a support agent who assists in the support of the software by answering questions from the end-users of the released software.

While some contributors can perform a combination of such tasks, a programmer cannot review self-written code. A different contributor from the project performs this task to avoid unconscious blindness to problems existent in one's own code. On the other hand, a programmer can be a documenter of the project, and provide support for the resulting software application, but these tasks can also be performed by different contributors to the project. Contributors can contribute to one or more different open source development software projects.

Gamification uses game thinking and game mechanics in non-game contexts to engage users in solving problems. In the context of the various embodiments of the present inventive concept, the development gamification computer server 105 facilitates the gamification of contributors and projects, thereby gamifying the total life cycle of a community-driven open source software development effort, as further described in detail below. Rewards such as points, achievements, bounties, and badges can be awarded to the contributors for performing activities associated with the projects, as also further described below.

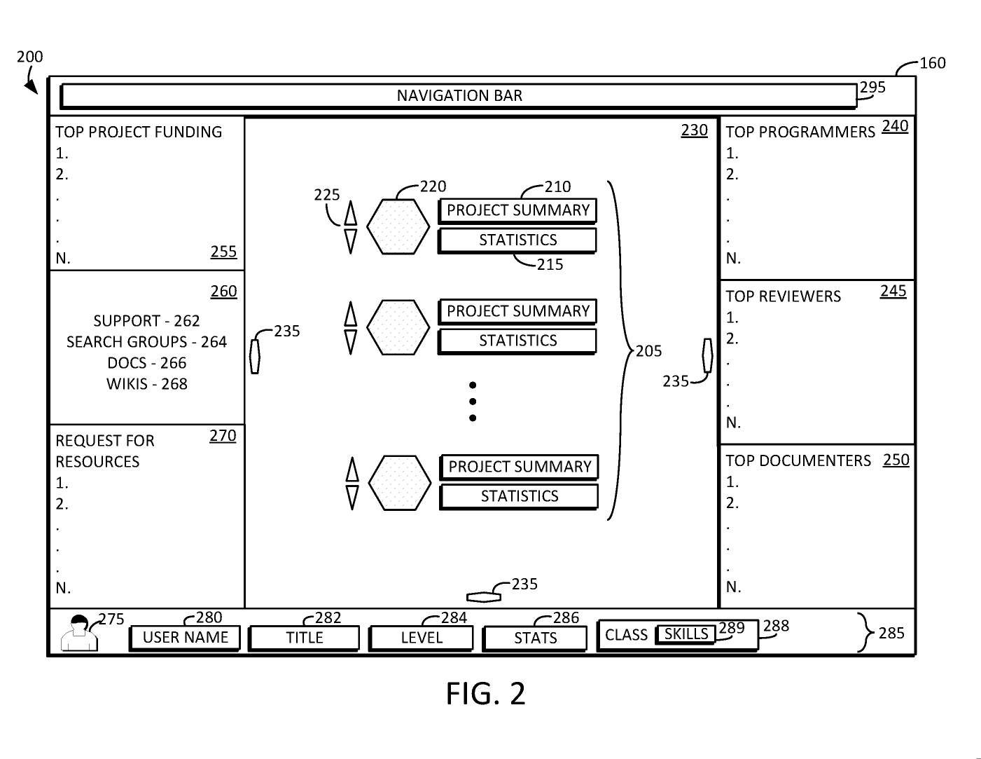

FIG. 2 illustrates a block diagram of an example development gamification interface 200 on a display device 160 of the system 100 of FIG. 1 including a project layout section 230 in accordance with various embodiments of the present inventive concept. Some elements of FIG. 2 are described above, and therefore, a detail description of such elements is not necessarily repeated. Reference is now made to FIGS. 1 and 2.

The interface 200 can be a front page or main page for interfacing with one or more contributors. The one or more contributors can interface with the development gamification computer server 105 via the one or more user devices (e.g., 160, 170, 175, 180, 185, 190, or the like), which can display the development gamification interface 200 via the display device 160. The one or more contributors can interact with the front page interface 200 (and for other interfaces described herein) using a mouse, a keyboard, a touch screen, or the like. The front page interface 200 can include a navigation bar 295. The navigation bar 295 can allow users to navigate to other parts of the user interface, to navigate to other views, to navigate to other projects, or the like. The users can interact with the navigation bar 295 using a mouse, keyboard, touch screen, or the like.

The front page interface 200 can include a variety of game metrics, top performers in a variety of categories, and projects. For example, the front page interface 200 can include a list of projects 205. Each project 205 can have a project summary 210, project statistics 215, a project icon 220, and a set of up/down voting designators 225.

The projects 205 can be sorted based on user-selectable criteria such as at least one of (a) popularity in terms of number of downloads, (b) user ratings, (c) recent updates, (e) featured placement, (f) paid placement, (g) points, or the like. The project statistics 215 can include at least one of (a) votes, (b) popularity, (c) age since last update, (d) user ratings, or the like. The users (e.g., other contributors) can vote up or down a particular project 205 by selecting an up designator of the up/down voting designators 225 or a down designator of the up/down voting designators 225. The votes can be reflected in the project statistics 215. The project tracking logic section 120 can receive the selections and inputs from the one or more contributors, track, and update the statistics 215 and other information related to the various projects.

The front page interface 200 can include one or more slider panes 235, which can be used for expanding or contracting a particular window within the interface 200. For example, the user can expand or contract the project layout section 230 by clicking and holding a slider pane 235, and dragging it in one direction or the other. When the display 160 is a touch screen, then the user can touch and slide the slider pane 235 one way or the other, and so forth. The user can also designate a default view of the various windows so that they are in a particular size arrangement by default when initially accessing the front page interface 200. The user can minimize or maximize any of the windows within the view of the front page interface 200. Such ability to customize the view applies not only to the front page interface 200, but to the other views and interfaces described below. Thus, a detailed description of this feature is not repeated with respect to the other embodiments below.

The development gamification computer server 105 can receive the contributor information 154 from the contributor, such as a desired user profile 285. The user profile 285 expresses information about the user's character or qualities. The user profile 285 can include a user-selectable icon 275, a user-selectable user name 280, a user-selectable title 282, a level 284, and user statistics 286, or other information such as the projects the user is associated with. The user-selectable icon 275 can be a picture of the user or a representative icon of the user. The user-selectable title 282 can be representative of the role the user has in terms of the kind of contributions the user is capable of making. The user-selectable title 282 can be selected from a list of predefined titles such as “Apprentice Coder,” “Expert Coder,” “Experienced QA Agent,” or the like. Alternatively, the user can be permitted to enter a customized title. The level 284 can be assigned to the user, and reflects an accumulation of effort (e.g., what the user does and what contributions are made), how much they do, and the quality of their work.

The contributor can select one or more areas of contribution (e.g., programmer, code-reviewer, quality assurance agent, documentor, support agent, or the like) which is referred to as their character class 288. Within each area of contribution within the character class 288, a contributor can indicate additional skills 289. The skills 289 can be user-indicated. For example, a programmer can indicate which programming languages the programmer has proficiency in, such as Ruby, C++, PHP, or the like. The contributor can select such skills 289 from a predefined list of skill, or alternatively, can type in the specific skill into a field provided in the user profile 285. The user profile 285 can be received and stored by the development gamification computer server 105. Specifically, the user profile logic section 115 can present user profile selections or information to the contributor, who in turn can respond via the user interface 200. The user profile logic section 115 can receive, process, and/or store the responses to further build the user profile 285. The user profile logic section 115 can receive the selections and inputs from the one or more contributors related to the user profile 285. Moreover, the user profile logic section 115 can track and update the user profile 285 and other information related to the users.

The contributor tracking logic section 140 of the development gamification computer server 105 can track the various contributors over time and update their level 284 and statistics 286. For example, the contributor tracking logic section 140 can assign a higher level 284 to the contributor when a large amount of contribution is made to a project, a medium level 284 to the contributor when a medium amount of contribution is made, or a lower level 284 to the contributor when a small amount of contribution is made, and so forth.

The contributor tracking logic section 140 can determine a quality factor associated with the contributor, which can impact the level 284. For example, the quality factor can be determined by a number of bugs found during a code review, voting by other contributors, or a combination of these factors. The contributor tracking logic section 140 can increase or decrease the level 284 based on the quality factor. The contributor tracking logic section 140 can also increase or decrease the level 284 based on the number of projects the contributor has contributed to. For example, if the contributor has contributed to a large number of projects, then the contributor tracking logic section 140 can assign a higher level 284, whereas if the contributor has contributed to few or no projects, then the contributor tracking logic section 140 can assign a lower level 284 to the contributors profile 285.

The level 284 can represent an overall or aggregate level of the contributor.

Alternatively or in addition, each skill 289 associated with the contributor can have its own level 284 tracked by the contributor tracking logic section 140. The contributor tracking logic section 140 can further track and assign point and rank statistics 286, as further described below. The user profile logic section 115 can store the profile 285 as, and access the profile 285 from, the contributor information 154 stored on the development gamification computer server 105, including the information tracked by the contributor tracking logic section 140.

A user can select a particular project from among the projects 205, which can cause additional information to be displayed on the front page interface 200. For example, funding or top funding information can be displayed in a top project funding section 255 for the selected project 205, or for all projects. The top project funding section 255 can display a total amount of funding received for the selected project 205 (or all projects), and/or a list of top donations sources and amounts received. Alternatively or in addition, the top project funding section 255 can indicate top bounties on outstanding bugs to be fixed, or other awards monetary or otherwise associated with the selected project 205, or associated with all projects 205. The bounty tracking logic section 130 can track and update the project funding section 255.

By way of another example, the front page interface 200 can include a request for resources section 270. The request for resources section 270 can include multiple positions, which can be sorted, for example, by type of position, by popularity of position, by positions having bounties or monetary incentives, by positions needed within the particular user's skill set, by contributors needed on projects to which the particular user is already a contributor, or the like. The positions can include, for example, programmers, code-reviewers, quality assurance agents, documentors, support agents, or the like. The request for resources section 270 can be directed to only the selected project 205. Alternatively, the request for resources section 270 can include all open positions for all projects 205. The opportunity tracking logic section 125 can track and update the request for resources section 270.

By way of yet other examples, the front page interface 200 can include at least one of a top programmers section 240, a top reviewers section 245, or a top documenters section 250. Each of the sections 240, 245, and 250 can be configurable by the user to display different information based on different sort or selection criteria. Each of the sections 240, 245, and 250 can be expanded or contracted as described in detail above. The contributor tracking logic section 140 can receive the sort or selection criteria from the user. The contributor tracking logic section 140 can track and update the top programmers section 240, the top reviewers section 245, and/or a top documenters section 250.

The top programmers section 240 can display top programmers to the selected project 205, or alternatively, can display the top programmers overall for all projects 205. The top programmers section 240 can display one or more other lists, such as top quality assurance agents, top programmers for a particular programming language, or other suitable metric that the user can select. The top reviewers section 245 can display top reviewers of the code to the selected project 205, or alternatively, can display the top reviewers overall for all projects 205. The top reviewers section 245 can display one or more other lists, such as top quality assurance agents, top bug catchers, reviewers who catch bugs during the review process, or the like. The top documenters section 250 can display top documenters of the code to the selected project 205, or alternatively, can display the top documenters overall for all projects 205. The top documenters section 250 can display one or more other lists, such as top support agents, top users who are providing support, or the like.

By way of still another example, the front page interface 200 can include a support section 260, which can display information about support issues for the selected project 205, or for all outstanding projects 205. The support section 260 can include at least one of support information 262, search groups 264, documentation 266, or support wikis 268. The support section 260 can display popular support issues. The support section 260 can display the support issues prioritized by subscriptions to projects and/or by hot support issues. For users who are already members of particular projects, the support section 260 can display support issues specific to those particular projects by default. In some embodiments, the support section 260 can display support issues for a particular project 205, or for all projects 205. The support section 260 can display recently assigned issues to the user, issues that have a highest priority, or the like. The bug fix tracking logic section 135 can receive information from the user regarding the support section 260, and/or can track or update the support section 260.

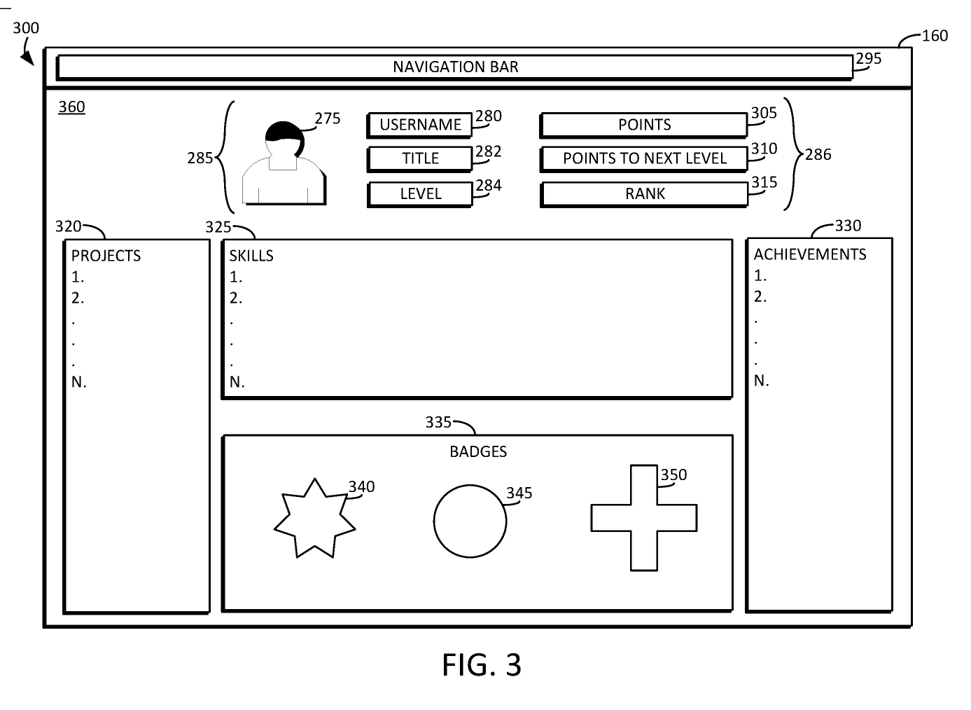

FIG. 3 illustrates a block diagram of an example development gamification interface 300 on a display device 160 of the system 100 of FIG. 1 including a user page layout section 360 in accordance with various embodiments of the present inventive concept. Some elements of FIG. 3 are described above, and therefore, a detail description of such elements is not necessarily repeated. Reference is now made to FIGS. 1 and 3.

The user page layout section 360 can include an expanded view of the user profile 285. For example, the user statistics 286 can be broken out into additional detail, including user points 305, points to a next (e.g., higher) user level 310, and user rank 315. The contributor tracking logic section 140 can assign the user points 305 to a particular user based on positive reviews by other users of the particular user's contributions.

Alternatively or in addition, the contributor tracking logic section 140 can assign the particular user points 305 when the particular user votes on matters related to the project or on other projects associated with the particular user. Alternatively or in addition, the contributor tracking logic section 140 can assign the particular user points 305 based on a number of downloads of the project by others. Alternatively or in addition, the user can receive points 305 through votes given by others to projects with which the particular user is associated.

The contributor tracking logic section 140 can track and update the points to the next level 310. The points to the next level 310 can indicate the points 305 needed before a particular user achieves a next or higher level 284. The points to next level 310 can be based on a graduated scale. In other words, the number of points needed increases with each next or higher level. In addition, the contributor tracking logic section 140 can assign the rank 315 to the particular user. The rank can be relative to all other users of the development gamification system 100 for any given skill set. For example, the rank 315 for a particular user who is a programmer can be relative to all other programmers who use the development gamification system 100.

Upon reaching a certain number of points 305, a particular user can level up. The levels 310 can add certain abilities to a user, such as the ability to moderate or contribute to a group or forum. For example, a user who has a relatively low level in the support category may not be able to answer questions in the forum in regard to a particular project, whereas a high level support agent may have their answers in the forum indicate a greater degree of authority. The answers as appearing in the forum can be color-coded to distinguish the level of the contributor from one answer to the next. When a project becomes stagnant, point penalties may be assessed. For example, a user's points 305 can be reduced when a particular project they are associated becomes stagnant or is otherwise unsuccessful. The contributor tracking logic section 140 can manage the leveling up of the users based on the acquired points 305.

The user page layout section 360 can include a reward exhibit section 335. The reward exhibit section 335 can display badges (e.g., 340, 345, and 350) earned by a particular user. The contributors can earn new badges for set tasks. For example, a badge can be awarded for first-time contributor achievements. By way of another example, a badge can be awarded when a contributor uploads a predefined number of files. By way of yet another example, a badge can be awarded that is associated with a monetary reward. By way of still another example, a badge can be awarded when the contributor places a bounty on a writing module, which incentivizes others to make additional contributions. The badges (e.g., 340, 345, and 350) can be similar to achievements (discussed in detail below), although achievements can be relatively easier to earn than the badges. Badges can be lost if the performance of a particular user fails to live up to the expectations that are associated with each badge. The contributor tracking logic section 140 can manage the awarding and rescinding of the badges (e.g., 340, 345, and 350) for each user based on the performance and contributions to projects (e.g., 205 of FIG. 2).

The user page layout section 360 can include a user project section 320. The user project section 320 can display a list of projects with which the particular user is a contributor, or with which the particular user is otherwise associated. The project tracking logic section 120 can manage and cause to be displayed the list of projects associated with the particular user.

Moreover, the user page layout section 360 can include a user achievements section 330, which can display a list of achievements that have been achieved by the particular user. The achievements can be minor or accumulative rewards, but something short of a badge. For example, creating a project can be considered an achievement. Adding code to a particular project can be an achievement. The achievements are minor recognitions that encourage basic participation in the development gamification system 100. The contributor tracking logic section 140 can manage the awarding of the achievements for each user based on their actions.

In addition, the user page layout section 360 can include a user skills section 325. The user skills section 325 can display a list of skills associated with the particular user. For example, the list of skills can include programming languages, areas of focus, or other abilities such as documenter, support agent, QA agent, or the like.

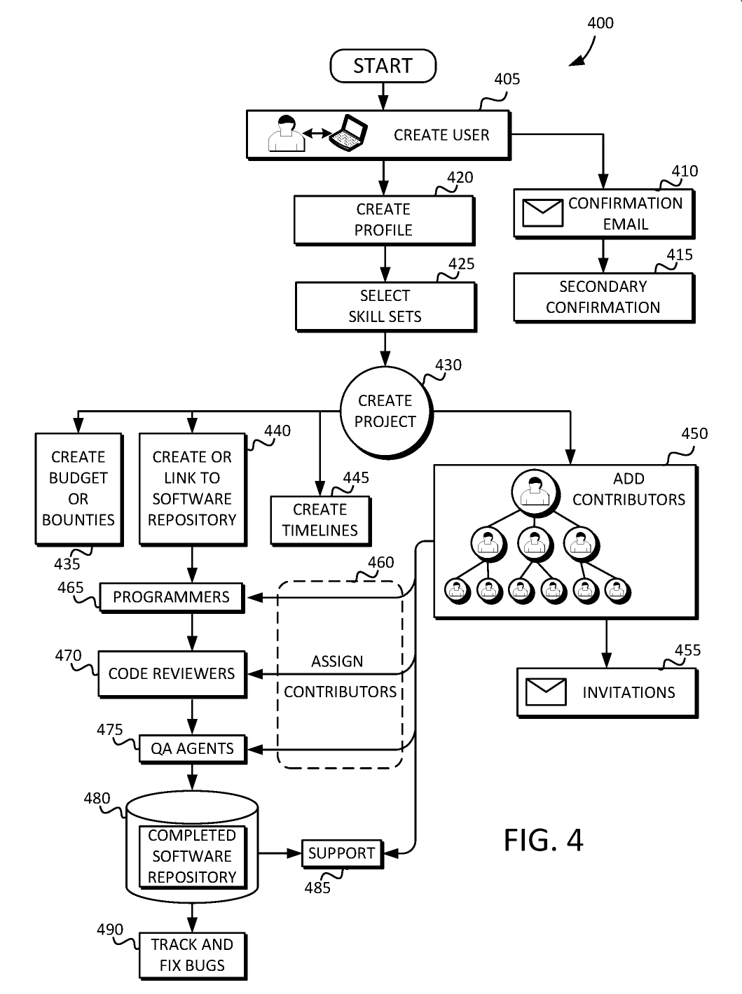

FIG. 4 is a flow diagram 400 illustrating a technique for constructing and gamifying an open source project in accordance with various embodiments of the present inventive concept. Some elements of FIG. 4 are described above, and therefore, a detail description of such elements is not necessarily repeated. Reference is now made to FIGS. 1 and 4.

The technique can begin at 405, where a user account and user profile can be created. The user can provide an email address, select a user name, select a title, begin a user profile, or the like. The user profile logic section 115 can receive the information entered by the user and can create the account and the user profile based on the information received.

The flow can proceed to 410, where a confirmation email can be sent to the registered email of the user to confirm the email and the account. Access to the features of the development gamification system 100 can be limited or prohibited until confirmation of the registered user email address. Such confirmation can be by way of a secondary confirmation 415, such as an embedded link or code in the confirmation email or sent to a mobile device, which must be clicked and followed, or entered, to confirm the registered email address. This provides an additional means of identifying the user. Completing the secondary confirmation can confer additional abilities or authorizations on the development gamification system 100, in addition to qualifying as an achievement, which can be displayed in the user achievements section 330 (of FIG. 3).

Meanwhile, the flow can proceed to 420, where a profile can be created. Having confirmed the user email and having logged into the development gamification computer server 105, the user can commence to create their profile or character. The user profile 285 can be partially completed initially, and then can continue to be filled out over time as the user participates in the development gamification system 100.

At 425, the user can select skills that they possess or will otherwise bring to bear on the development gamification system 100. For example, the user can select a programming language such as Python. The user can advance (e.g., earn points, achievements, bounties, badges, or the like) on the development gamification system 100 when adding code that corresponds (e.g., Python code) to the selected skill. The user profile logic section 115 can manage the building up of the user profile 285 of the user over time.

At 430, a project can be created. The project tracking logic section 120 can receive a request from the user to create a new project, and can create the new project. Alternatively or in addition, the user can join a preexisting project. In some embodiments, one or more projects are invite-only. In some embodiments, one or more projects can accept any suitable volunteers. In some embodiments, one or more projects can accept conditional volunteers, which can be ultimately approved or rejected by a project head. The project head can be another user who created the project or has become the main user in charge of the project.

At 450, additional contributors can be added to the project. The additional contributors can be existing users of the development gamification system 100. Alternatively or in addition, the additional contributors can be invited to join as new users of the development gamification system 100 to participate in the new project. Invitations can be sent at 455 to be contributors of a project. For example, the invitations can be email invitations sent to either current users or would-be users of the development gamification system 100. The project tracking logic section 120 can automatically send the email invitations based on the user's request. The user requesting that the invitations be sent can be awarded (e.g., points, achievements, bounties, or badges) for invitees who accept the invitation and join the development gamification system 100. The invited persons can then create an account and user profile of their own on the development gamification system 100, or otherwise login using their existing account.

At 445, a timeline for the project can be created. Timelines relate to project management. One or more contributors can manage the project including deadlines and assignments associated with the project. The contributors can be incentivized and rewarded for meeting their project timeline goals. The project tracking logic section 120 can create, manage, and track the timeline and progress associated with the timeline. The timeline and associated features are described in further detail below.

At 440, the software repository 157 can either be created or linked to. The contributors can add their source code to the software repository 157, or link their source code via an application programming interface (API) to another existing repository such as Github®. For example, the project source code can be published on Github®, and in addition, linked to the software repository 157 to allow access to code review tools and to the development gamification system 100 for the project.

At 460, contributors can be assigned to various roles from among the contributors added at 450. For example, the contributors can be assigned at 460 to be programmers at 465, to be code reviewers at 470, and/or to be QA agents at 475. The programmers assigned at 465 can publish their source code to Github® and/or link their code to the software repository 157. The code-reviewers assigned at 470 can be added to the development gamification system 100 in general and/or assigned to existing code for an existing project. It is generally accepted that source code that is reviewed has fewer bugs. The code-reviewers can be graded on their reviews. When the code-reviewers fail to catch bugs, they can lose points. Conversely, when the code-reviewers are proficient in catching bugs, they can gain points, achievements, or badges. The QA agents added at 475 can help ensure that bugs are caught before the software is related, which ensures a better overall project. The QA agents can be incentivized to find bugs, to test the software, and/or to provide feedback. For example, the QA agents can be awarded points, achievements, bounties, and/or badges for such tasks.

After having exerted their efforts on developing the project, the project can be made available for download from the completed software repository at 480. The downloadable project can include one or more software packages. Multiple versions of the package can be made available in a variety of formats. The contributors can promote and distribute the project to end-users. The project can be made available for distribution, including in some cases, the full source code. Projects can be incentivized (e.g., by rewarding the contributors with points, achievements, bounties, badges, or the like) to make new releases periodically to show that they are still active. Projects and/or their contributors can lose points for becoming stale, or for not enhancing their project over time.

At 490, bugs can be tracked and fixed. The bug fix tracking logic section 135 can manage and track the fixing of the bugs. Both for released and pre-released projects, the bug fix tracking logic section 135 can track and quash bugs in the software. The bug fix tracking logic section 135 can provide both an open and a closed version of the bug tracking. For example, QA agents and programmers can manage and add bug descriptions on pre-released projects and associated software in a closed version of the bug tracking provided by the bug fix tracking logic section 135. After the project has been released to the end-users, bug fix tracking logic section 135 can provide an open version of the bug tracking so that the end-users themselves can manage and add bug descriptions on the released project and associated software modules. The end-users can create an account on the development gamification system 100 to be able to submit bug descriptions, although they need not be made contributors or members of the project. Certain bugs can be associated with the user who submitted them, and for users who are contributors, such contributors can be awarded points, achievements, bounties, badges, or the like, when the bugs are fixed.

At 485, users can be incentivized (e.g., points, achievements, bounties, or badges awarded) to provide support and documentation for the project and associated software modules. By encouraging users to document the software, the end-users have a better user experience. Projects can also contain a wiki for additional information to help organize the documentation as well as one or more discussion forums to facilitate collaboration on updates and improvements to the project over time. The one or more discussion forums can be moderated or open. In addition, the users can be incentivized to provide support for the project, which provides a better experience for the end-users. Such post-release support also demonstrates to the wider end-user community that the project is alive and well.

At 435, a budget and/or bounties can be created. The bounty tracking logic section 130 can create the budget and/or the bounties in response to requests received from a user. Bounties can help fund the time devoted by contributors to a particular project. Such bounties can be linked to a particular project, and/or to a funding website in which a user can set a monetary value to the bounty. The bounty can be specific to the creation and adding of a feature to the project, to the funding of the project itself, and/or to the funding for fixing of particular bugs in the project software. The contributors can receive funds from the bounty for satisfying the criteria and conditions of the bounty. Bounty metrics can be verified by the bounty tracking logic section 130 to ensure fairness. Any interested person, including contributors, users, end-users, or the like, can establish a bounty associated with any project. The bounty tracking logic section 130 can receive the requests to establish the bounties and manage the bounties and distribution of funds to the appropriate contributors.

It will be understood that the steps shown in FIG. 4 need not be performed in the order shown, but rather, can be performed in a different order or with intervening steps.

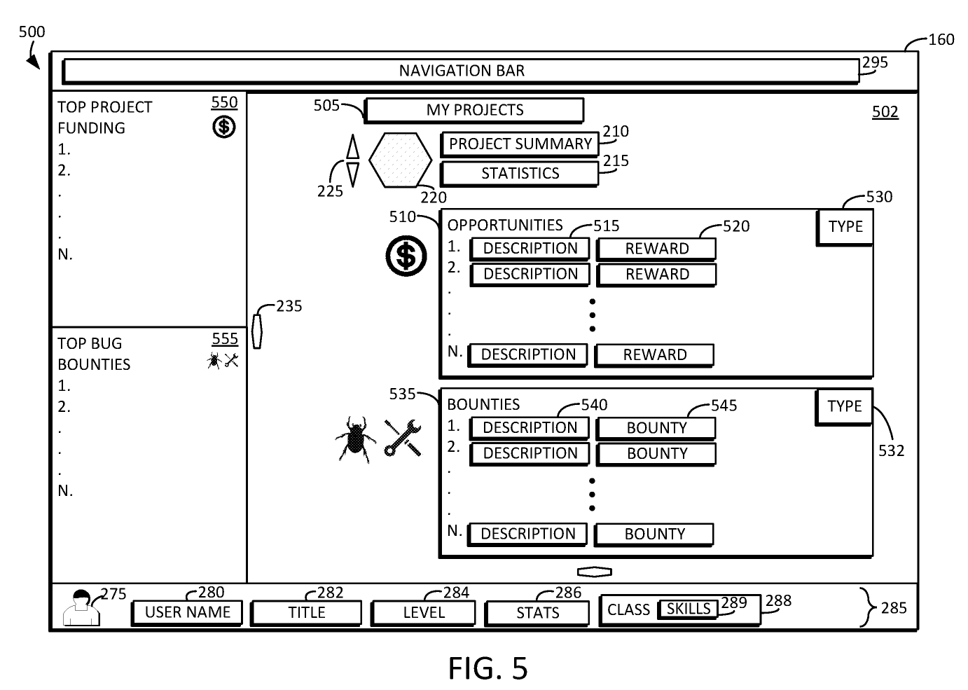

FIG. 5 illustrates a block diagram of an example development gamification interface 500 on a display device 160 of the system 100 of FIG. 1 including an incentive layout section 502 in accordance with various embodiments of the present inventive concept. Some elements of FIG. 5 are described above, and therefore, a detail description of such elements is not necessarily repeated. Reference is now made to FIGS. 1 and 5.

The development gamification interface 500 can include a top project funding section 550, which can list the projects having the most funding available to interested contributors. The top project funding section 550 can incentivize users to become contributors to one or more well-funded projects.

The development gamification interface 500 can include a top bug bounties section 555, which can list bugs having the most funding available to interested contributors for fixing the bugs. The bug list can span multiple projects. The bug bounties can be made available to a particular contributor based on a finding determined by a project head of a project of whether or not the targeted bug is fixed by the particular contributor. The bug bounty can include an award of points and/or a monetary award to the particular contributor. For example, a security bug can have a high bounty as it is important to the integrity of a project, and fixing such a security bug can result in both points and a monetary award. In addition, a badge may be awarded for contributors who have fixed a predefined number of bugs over time. The bounty tracking logic section 130 and the bug fix tracking logic section 135 can work in tandem to manage and track the bug bounties section 555.

The incentive layout section 502 of the development gamification interface 500 can include a list of “my projects” 505 associated with a particular contributor. The incentive layout section 502 can also include a project summary 210 for a particular project selected from among the my projects list 505. The project summary 210 can show general information about a project. For a project head, the project summary 210 can also include the ability to create incentives or link to incentives from another funding site, which can be listed in the incentive layout section 502, as further described below. In addition, the statistics 215 for the particular project can also be displayed.

The incentive layout section 502 can further include an opportunities description section 510, which can list opportunities, such as monetary opportunities, for particular projects, all projects, or a selected project. Each opportunity can have a description 515 and a reward 520, which can be displayed in the opportunities description section 510. In some embodiments, the opportunities can be sorted by type 530. The opportunity tracking logic section 125 can manage, track, and update the opportunities description section 510. The monetary incentives can be used to incentivize the creation of specific features for a particular project. Some or all of the available monetary awards can be displayed in the opportunities description section 510. Alternatively or in addition, a project can deliver a cache of points for users who contribute to a particular project. Such point caches can also be displayed in the opportunities description section 510.

The incentive layout section 502 can further include a bounty description section 535, which can list bounties for particular projects, all projects, or a selected project. Each bug bounty can have a description 540 and a bounty 545, which can be displayed in the bounty description section 535. In some embodiments, the bug bounties can be sorted by type 532. The bounty tracking logic section 130 and the bug fix tracking logic section 135 can work in tandem to manage, track, and update the bounties description section 535. The bounty description section 535 can permit a project head of a project to create bug bounties. Alternatively or in addition, a user can use the bounty description section 535 to view bounties that have been created. The bug bounties can have monetary incentives associated therewith. The monetary incentives can be from the development gamification system 100, or alternatively, can be linked in from a separate funding site. The project head can determine which bugs receive which bounties. Alternatively or in addition, the project head can offer points for fixing one or more of the bugs. The points can be awarded by themselves to the contributor who fixes a particular bug, or in addition to a monetary bounty for fixing the bug.

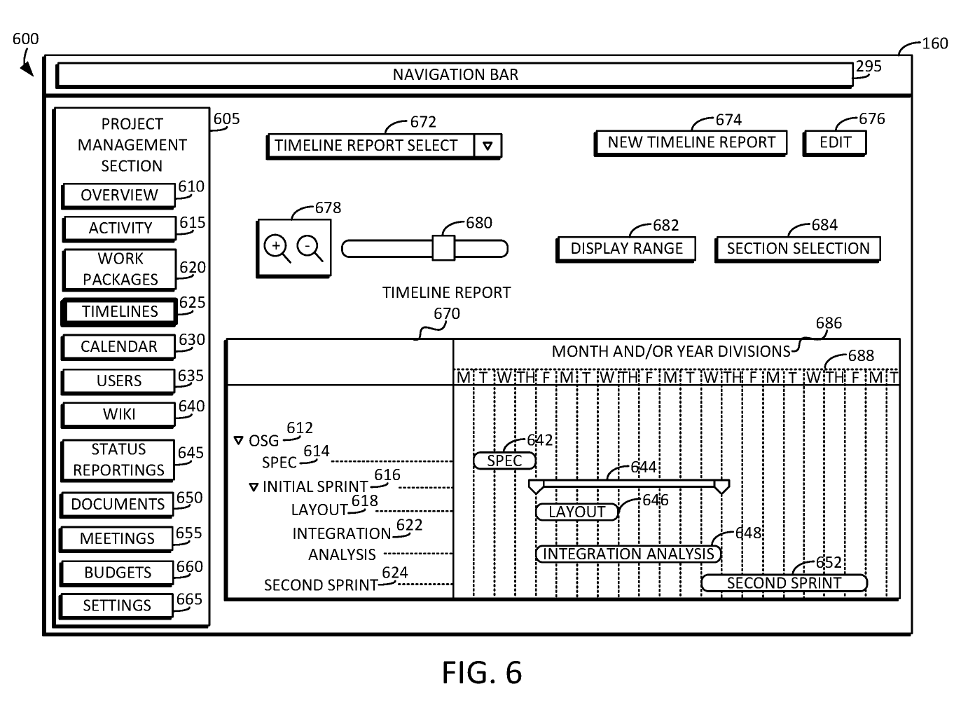

FIG. 6 illustrates a block diagram of an example development gamification interface 600 on a display device 160 of the system 100 of FIG. 1 including a project management section 605 in accordance with various embodiments of the present inventive concept. Some elements of FIG. 6 are described above, and therefore, a detail description of such elements is not necessarily repeated. Reference is now made to FIGS. 1 and 6.

The development gamification interface 600 provides a management suite for projects. The project management suite assists in the tracking of project deadlines and milestones within a particular project. In addition, the management suite provides accountability for contributors associated with the particular project. Contributors that hit milestones or complete an assigned tasks can receive awards (e.g., points, achievements, bounties, badges, or the like) for completing tasks or reaching the milestones. The management suite also provides metrics for proving that users are contributing, which can help determine the awards. The status of a particular project can be tracked from beginning to end as well as planning for future releases or versions. The project tracking logic section 120 can manage, track, and update the project management suite.

The development gamification interface 600 can include a project management section 605. The project management section 605 can include multiple panes for configuring project management features. For example, the project management section 605 can include at least one of an overview pane 610, an activity pane 615, a work packages pane 620, a timelines pane 625, a calendar pane 630, a users pane 635, a wiki pane 640, a status reportings pane 645, a documents pane 650, a meetings pane 655, a budgets pane 660, or a settings pane 665. Upon selection of each of the panes, a corresponding view can be displayed on the display device 160 corresponding to the selected pane.

For example, selecting the overview pane 610 can cause an overview of all of the projects to be displayed. Selecting the activity pane 615 can cause the overall activity for projects to be displayed. Selecting the work package pane 620 can cause work packages information to be displayed. Selecting the timelines pane 625 can cause timeline information to be displayed, as shown in this figure. Selecting the calendar pane 630 can cause a calendar to be displayed having the various projects shown within the calendar. Selecting the users pane 635 can cause a list of all users of the development gamification system 100 to be displayed. Selecting the wiki pane 640 can cause one or more wikis to be displayed. Selecting the status reportings pane 645 can cause one or more status reports for one or more projects to be displayed. Selecting the documents pane 650 can cause one or more documents to be displayed. Selecting the meetings pane 655 can cause one or more planned meetings to be displayed. Selecting the budgets pane 660 can cause one or more project budgets to be displayed. And selecting the settings pane 665 can cause a settings view to be displayed in which one or more settings can be adjusted for the development gamification system 100.

The project management section 605 provides users with a well-featured open source project management suite. Additional users can be added and assigned to tasks, projects, bugs, and so forth. Tasks for a particular project can be added. The general management of milestones and other information associated with projects can be managed via the project management section 605. The project tracking logic section 120 can manage, track, and update the project management section 605.

When the timelines pane 625 is selected, as shown in FIG. 6, a project tracking timeline report chart 670 can be displayed. The project tracking timeline report chart 670 can track the product deliverables of a particular project. Users can view sprints (e.g., 616 and 624) or sub-tasks (e.g., 618 and 622). The users can view their individual assignments or due dates. The users can view the project as a whole, or see the release schedule for different versions of the project.

In this example embodiment, the project “OSG” is shown as 612 in the project tracking timeline report chart 670 as an expandable project thread with a number of tasks and sub-tasks viewable upon expansion of the thread. The project OSG 612 includes a spec 614 task, which corresponds to a spec period of time indicator bar 642 that is allocated to the spec 614 task. The project OSG 612 further includes an initial sprint 616, which corresponds to an initial sprint period of time indicator bar 644 that is allocated to the initial sprint 616. The initial sprint 616 can include sub-tasks layout 618 and integration analysis 622. The sub-task layout 618 can correspond to a sub-task layout period of time indicator bar 646 that is allocated to the sub-task layout 618. The sub-task integration analysis 622 can correspond to a sub-task integration analysis period of time indicator bar 648 that is allocated to the sub-task integration analysis 622. The project OSG 612 can further include a second sprint 624, which corresponds to a second sprint period of time indicator bar 652 that is allocated to the second sprint 624.

The project tracking timeline report chart 670 can be divided into month and/or year divisions 686. The month and/or year divisions 686 can be further divided into week or day divisions 688. The scale of the project tracking timeline report chart 670 can be adjusted by a user. For example, the user can limit the view to a limited time range, or adjust the general scope of the project. More specifically, the user can zoom in or out using zoom tool 678. The user can change the scale using a slider bar 680 to widen or narrow the view of the timeline report 670, or alternatively, to slide or jump to different areas of the timeline report 670. The user can change the scale by entering a display time range using the display range tool 682. The user can further change the scale or scope of view by focusing on a particular section using the section selection tool 684.

The user can create a new project tracking timeline report 670 using the new timeline report tool 674. The new project tracking timeline report 670 can be associated with a particular project. Such ability to create a new project tracking timeline report 670 can be limited to only certain users associated with the particular project. The project tracking timeline report 670 can be placed into an edit mode by selecting the edit tool 676. Different timeline reports can be viewed using the timeline report select tool 672. The project tracking logic section 120 can manage, track, and update the project tracking timeline report 670.

Improving the methods by which open source software development occurs includes changing the dynamic of development to incorporate game elements into the process. For example, adding rewards, points, achievements, bounties, badges, prizes, and other benefits help to create a more successful atmosphere. Creating an environment that incorporates elements from games into the community open source development environment creates a new dynamic for encouraging development. People like to receive rewards for their efforts—even if they are nebulous. Such nebulous rewards might have no value besides bragging rights, but yet, are still effective in incentivizing behavior. People compete for them.

By providing game-like incentives to the task of community open source development, the systems and methods disclosed herein help to motivate users to not only perform the most desired tasks, such as coding, but also the less desirable actions like code review, documentation, quality assurance, testing, security analysis, and the like. In this manner, all steps along the software development path can be incentivized. Even scheduling and meeting deadlines for enhancements, bug fixes, and security auditing can benefit from an award system.

Contributions and points acquired help build up a user's reputation. By reaching a threshold in performing tasks, one demonstrates expertise in a particular field. This is reflected in a game by leveling up. For example, a second level wizard is seen as more proficient than a first level wizard. By applying this concept to development, a user can demonstrate their expertise in a particular task through their performance of the task. Further, the user's expertise can be challenged through the use of rating their performance based upon the views of the community. Such voting process can help assure that quality is maintained. Users can rate another user and penalize poor quality, thereby causing the originator to lose points or experience.

A leaderboard can be provided, which demonstrates who are the leaders among a group of users, thereby highlighting who the top performers are. This is a further incentive for users—the desire to have their skills recognized. When these elements are incorporated into the process of community created open source software using the development gamification computer server 105, an environment is created that allows the best projects to receive the most attention, the best contributors to receive recognition, and motivation to maintain, develop and advance the community-driven open source software development project.

Thus, a system and method for developing community open source software with elements of gamification to incentive the participants is provided. Game elements can be adapted to a collaborative coding environment to encourage participation. Incentive elements such as points, achievements, bounties, badges, awards, votes, or the like, can be accumulated by participants through activities like contributing code, code review, documentation, quality assurance, voting for projects, security assessments, or the like. Voting can help establish hierarchies of projects based on popularity, quality, or usefulness.

Some embodiments include a development gamification system. The development gamification system can include a physical input/output unit coupled to a cloud and configured to transmit and receive development gamification information to and from the cloud, a storage device configured to store the development gamification information, and to store a software repository including one or more community driven incentivized open source software projects developed by one or more users, and a user interface logic section coupled to the physical input/output unit, wherein the user interface logic section is configured to interface with the one or more users via corresponding one or more user devices and the cloud, and to provide a development gamification interface to incentivize the one or more users to develop the one or more open source software projects.

In some embodiments, the development gamification system includes a microprocessor configured to process the development gamification information, and to process information from the user interface logic section in order to provide the development gamification interface to incentivize the one or more users to develop the one or more open source software projects.

In some embodiments, the development gamification system includes a user profile logic section configured to receive user information from the one or more users, and to provide a user profile section in the development gamification interface associated with each of the one or more users, wherein the user profile section includes a user-selectable user icon and a user-selectable user title.

In some embodiments, the user profile section further includes a user level configured to reflect an accumulation of effort and contribution made by each of the one or more users toward the one or more open source software projects, and user statistics configured to reflect a number of points earned by each of the one or more users, a rank earned by each of the one or more users, and points to achieve a higher user level.

In some embodiments, the user profile section further includes a character class having user-indicated skills that correspond to one or more proficiencies possessed by each of the one or more users.

In some embodiments, the development gamification system further includes a project tracking logic section configured to provide a project layout section in the development gamification interface, wherein the project layout section includes a list of the one or more open source software projects, wherein each project in the list includes a project summary, project statistics, a project icon, and a set of up/down voting designators, and wherein the project tracking logic section is configured to receive one or more upvotes and one or more downvotes via the set of up/down voting designators from the one or more users.

In some embodiments, the project tracking logic section is further configured to provide a project funding section including a list of top funding sources and funding amounts received for a selected project from among the one or more projects listed in the project layout section, a top programmers section including programmers who have made relatively more contributions toward the selected project from among the one or more projects listed in the project layout section compared to other programmers from among the one or more users, a top reviewers section including reviewers who have made relatively more contributions toward the selected project from among the one or more projects listed in the project layout section compared to other reviewers from among the one or more users, and a top documenters section including documenters who have made relatively more contributions toward the selected project from among the one or more projects listed in the project layout section compared to other documenters from among the one or more users.

In some embodiments, the development gamification interface further includes a user page layout section. The page layout section can include a user profile section including a user-selectable user icon, a user-selectable user title, and user statistics including a number of points earned by a particular user from among the one or more users, a rank earned by the particular user, and points to achieve a higher user level, a user skills section configured to display a list of skill associated with the particular user, a projects section configured to display a list of projects from among the one or more open source software projects with which the particular user is a contributor, an achievements section configured to display a list of achievements that have been achieved by the particular user associated with the development of the one or more open source software projects, and a reward exhibit section configured to display one or more badges earned by the particular user.

In some embodiments, each achievement listed in the achievements section corresponds to a relatively minor accomplishment including at least one of (a) a first-time contribution toward the development of the one or more open source software projects, (b) a confirmation of a registered email, or (c) a creation of a new project. In some embodiments, each badge displayed in the reward exhibit section corresponds to a relatively major accomplishment including at least one of (a) a predefined number of uploads made by the particular user, (b) a monetary award awarded to the particular user, or (c) a bounty placed on a writing module by the particular user.

In some embodiments, the development gamification system further includes a project tracking logic section, wherein the development gamification interface further includes a project management section. The project management section can include an overview pane, an activity pane, a work packages pane, a timelines pane, a calendar pane, a users pane, a wiki pane, a status reportings pane, a documents pane, a meetings pane, a budgets pane, and a settings pane, wherein in response to a selection of the overview pane, the project tracking logic section is configured to display an overview of all of the one or more open source projects in the development gamification interface, wherein in response to a selection of the activity pane, the project tracking logic section is configured to display overall activity for the one or more open source projects in the development gamification interface, wherein in response to a selection of the work packages pane, the project tracking logic section is configured to display work packages in the development gamification interface, wherein in response to a selection of the timelines pane, the project tracking logic section is configured to display timeline information in the development gamification interface, wherein in response to a selection of the calendar pane, the project tracking logic section is configured to display a calendar having the one or more open source projects shown within the calendar in the development gamification interface, wherein in response to a selection of the users pane, the project tracking logic section is configured to display a list of all of the one or more users, wherein in response to a selection of the wiki pane, the project tracking logic section is configured to display one or more wikis in the development gamification interface, wherein in response to a selection of the status reporting pane, the project tracking logic section is configured to display one or more status reports in the development gamification interface, wherein in response to a selection of the documents pane, the project tracking logic section is configured to display one or more documents in the development gamification interface, wherein in response to a selection of the meetings pane, the project tracking logic section is configured to display one or more meetings in the development gamification interface, wherein in response to a selection of the budgets pane, the project tracking logic section is configured to display one or more budgets in the development gamification interface, and wherein in response to a selection of the settings pane, the project tracking logic section is configured to display one or more settings in the development gamification interface.

In some embodiments, the development gamification system further includes a project tracking logic section, wherein the development gamification interface further includes a project management section including a timelines pane, wherein in response to a selection of the timelines pane, the project tracking logic section is configured to display timeline information in the development gamification interface, and wherein the timeline information includes a project tracking timeline report configured to track product deliverables of a particular open source project from among the one or more open source projects.

In some embodiments, the project tracking timeline report includes an expandable project thread corresponding to the particular open source project, wherein the expandable project thread includes a plurality of tasks and sub-tasks, the project tracking timeline report further includes a period of time indicator bar for each of the tasks representing a period of time allocated to each of the tasks, and the project tracking timeline report further includes a period of time indicator bar for each of the sub-tasks representing a period of time allocated to each of the sub-tasks.

In some embodiments, the project tracking logic section is configured to provide a zooming tool configured to zoom in or out the project tracking timeline report, the project tracking logic section is configured to provide a slider bar configured to slide or jump to different areas of the project tracking timeline report, the project tracking logic section is configured to provide a display range tool configured to cause the project tracking timeline report to show a particular designated time range, and the project tracking logic section is configured to provide a section selection tool configured to cause the project tracking timeline report to show a particular designated section.

In some embodiments, the project tracking logic section is configured to provide a new timeline report tool configured to provide an option for creating a new project tracking timeline report for the particular open source project, and the project tracking logic section is configured to provide a timeline report select tool configured to provide an option to view different project tracking timeline reports for the particular open source project.

In some embodiments, the development gamification interface further includes an incentive layout section. The incentive layout section can include a selected open source project from among the one or more open source projects, wherein the selected open source project includes a project summary and project statistics, an opportunities description section including a list of opportunities for the selected open source project, wherein each opportunity in the list includes a description and a reward, and a bounty description section including a list of bounties for the selected open source project, wherein each bounty in the list includes a description and a bounty amount.

In some embodiments, the reward includes a monetary award and a points award. In some embodiments, the reward includes only a points award. In some embodiments, the reward includes only a monetary award.

In some embodiments, the development gamification interface further includes a top project funding section including a list of projects having funding available to interested contributors from among the one or more users, and a top bug bounties section including a list of bugs having funding available to interested contributors from among the one or more users for fixing bugs.

The following discussion is intended to provide a brief, general description of a suitable machine or machines in which certain aspects of the inventive concept can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the inventive concept can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the inventive concept with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the inventive concept to particular embodiment configurations. As used herein, these terms can reference the same or different embodiments that are combinable into other embodiments.

Embodiments of the invention may include a non-transitory machine-readable medium comprising instructions executable by one or more processors, the instructions comprising instructions to perform the elements of the embodiments as described herein.

Consequently, in view of the wide variety of permutations to the embodiments described herein, this detailed description and accompanying material is intended to be illustrative only, and should not be taken as limiting the scope of the inventive concept. What is claimed as the invention, therefore, is all such modifications as may come within the scope and spirit of the following claims and equivalents thereto.

1. A development gamification system, comprising:
a physical input/output unit coupled to a cloud and configured to transmit and receive development gamification information to and from the cloud;
a storage device configured to store the development gamification information, and to store a software repository including one or more community driven incentivized open source software projects developed by one or more users; and
a user interface logic section coupled to the physical input/output unit, wherein the user interface logic section is configured to interface with the one or more users via corresponding one or more user devices and the cloud, and to provide a development gamification interface to incentivize the one or more users to develop the one or more open source software projects.

2. The system of claim 1, further comprising:
a microprocessor configured to process the development gamification information, and to process information from the user interface logic section in order to provide the development gamification interface to incentivize the one or more users to develop the one or more open source software projects.

3. The system of claim 1, further comprising:
a user profile logic section configured to receive user information from the one or more users, and to provide a user profile section in the development gamification interface associated with each of the one or more users,
wherein the user profile section includes a user-selectable user icon and a user-selectable user title.

4. The system of claim 3, wherein the user profile section further includes:
a user level configured to reflect an accumulation of effort and contribution made by each of the one or more users toward the one or more open source software projects; and
user statistics configured to reflect a number of points earned by each of the one or more users, a rank earned by each of the one or more users, and points to achieve a higher user level.

5. The system of claim 4, wherein the user profile section further includes a character class having user-indicated skills that correspond to one or more proficiencies possessed by each of the one or more users.

6. The system of claim 1, further comprising:
a project tracking logic section configured to provide a project layout section in the development gamification interface, wherein the project layout section includes a list of the one or more open source software projects,
wherein each project in the list includes a project summary, project statistics, a project icon, and a set of up/down voting designators, and wherein the project tracking logic section is configured to receive one or more upvotes and one or more downvotes via the set of up/down voting designators from the one or more users.

7. The system of claim 6, wherein the project tracking logic section is further configured to provide:
a project funding section including a list of top funding sources and funding amounts received for a selected project from among the one or more projects listed in the project layout section;
a top programmers section including programmers who have made relatively more contributions toward the selected project from among the one or more projects listed in the project layout section compared to other programmers from among the one or more users;
a top reviewers section including reviewers who have made relatively more contributions toward the selected project from among the one or more projects listed in the project layout section compared to other reviewers from among the one or more users; and
a top documenters section including documenters who have made relatively more contributions toward the selected project from among the one or more projects listed in the project layout section compared to other documenters from among the one or more users.

8. The system of claim 1, wherein the development gamification interface further comprises a user page layout section, comprising:
a user profile section including a user-selectable user icon, a user-selectable user title, and user statistics including a number of points earned by a particular user from among the one or more users, a rank earned by the particular user, and points to achieve a higher user level;
a user skills section configured to display a list of skill associated with the particular user;
a projects section configured to display a list of projects from among the one or more open source software projects with which the particular user is a contributor;
an achievements section configured to display a list of achievements that have been achieved by the particular user associated with the development of the one or more open source software projects; and
a reward exhibit section configured to display one or more badges earned by the particular user.

9. The system of claim 8, wherein:
each achievement listed in the achievements section corresponds to a relatively minor accomplishment including at least one of (a) a first-time contribution toward the development of the one or more open source software projects, (b) a confirmation of a registered email, or (c) a creation of a new project; and
each badge displayed in the reward exhibit section corresponds to a relatively major accomplishment including at least one of (a) a predefined number of uploads made by the particular user, (b) a monetary award awarded to the particular user, or (c) a bounty placed on a writing module by the particular user.

10. The system of claim 1, further comprising a project tracking logic section, wherein the development gamification interface further comprises a project management section, comprising:
an overview pane, an activity pane, a work packages pane, a timelines pane, a calendar pane, a users pane, a wiki pane, a status reportings pane, a documents pane, a meetings pane, a budgets pane, and a settings pane,
wherein in response to a selection of the overview pane, the project tracking logic section is configured to display an overview of all of the one or more open source projects in the development gamification interface,
wherein in response to a selection of the activity pane, the project tracking logic section is configured to display overall activity for the one or more open source projects in the development gamification interface,
wherein in response to a selection of the work packages pane, the project tracking logic section is configured to display work packages in the development gamification interface,
wherein in response to a selection of the timelines pane, the project tracking logic section is configured to display timeline information in the development gamification interface,
wherein in response to a selection of the calendar pane, the project tracking logic section is configured to display a calendar having the one or more open source projects shown within the calendar in the development gamification interface,
wherein in response to a selection of the users pane, the project tracking logic section is configured to display a list of all of the one or more users,
wherein in response to a selection of the wiki pane, the project tracking logic section is configured to display one or more wikis in the development gamification interface,
wherein in response to a selection of the status reporting pane, the project tracking logic section is configured to display one or more status reports in the development gamification interface,
wherein in response to a selection of the documents pane, the project tracking logic section is configured to display one or more documents in the development gamification interface,
wherein in response to a selection of the meetings pane, the project tracking logic section is configured to display one or more meetings in the development gamification interface,
wherein in response to a selection of the budgets pane, the project tracking logic section is configured to display one or more budgets in the development gamification interface, and
wherein in response to a selection of the settings pane, the project tracking logic section is configured to display one or more settings in the development gamification interface.

11. The system of claim 1, further comprising a project tracking logic section, wherein the development gamification interface further comprises a project management section including a timelines pane,
wherein in response to a selection of the timelines pane, the project tracking logic section is configured to display timeline information in the development gamification interface, and
wherein the timeline information includes a project tracking timeline report configured to track product deliverables of a particular open source project from among the one or more open source projects.

12. The system of claim 11, wherein:
the project tracking timeline report includes an expandable project thread corresponding to the particular open source project, wherein the expandable project thread includes a plurality of tasks and sub-tasks,
the project tracking timeline report further includes a period of time indicator bar for each of the tasks representing a period of time allocated to each of the tasks, and
the project tracking timeline report further includes a period of time indicator bar for each of the sub-tasks representing a period of time allocated to each of the sub-tasks.

13. The system of claim 12, wherein:
the project tracking logic section is configured to provide a zooming tool configured to zoom in or out the project tracking timeline report,
the project tracking logic section is configured to provide a slider bar configured to slide or jump to different areas of the project tracking timeline report,
the project tracking logic section is configured to provide a display range tool configured to cause the project tracking timeline report to show a particular designated time range, and
the project tracking logic section is configured to provide a section selection tool configured to cause the project tracking timeline report to show a particular designated section.

14. The system of claim 13, wherein:
the project tracking logic section is configured to provide a new timeline report tool configured to provide an option for creating a new project tracking timeline report for the particular open source project, and
the project tracking logic section is configured to provide a timeline report select tool configured to provide an option to view different project tracking timeline reports for the particular open source project.

15. The system of claim 1, wherein the development gamification interface further comprises an incentive layout section, comprising:
a selected open source project from among the one or more open source projects, wherein the selected open source project includes a project summary and project statistics;
an opportunities description section including a list of opportunities for the selected open source project, wherein each opportunity in the list includes a description and a reward; and
a bounty description section including a list of bounties for the selected open source project, wherein each bounty in the list includes a description and a bounty amount.

16. The system of claim 15, wherein the reward includes a monetary award and a points award.

17. The system of claim 15, wherein the reward includes a points award.

18. The system of claim 15, wherein the reward includes a monetary award.

19. The system of claim 15, wherein the development gamification interface further comprises:
a top project funding section including a list of projects having funding available to interested contributors from among the one or more users; and
a top bug bounties section including a list of bugs having funding available to interested contributors from among the one or more users for fixing bugs.
